(19) United States
(12) Patent Application Publication
(10) Pub. No.: US 2007/0146966 A1
(43) Pub. Date: Jun. 28, 2007

(54) Ultracapacitor electrode with controlled binder content

(76) Inventors: Linda Zhong, San Diego, CA (US); Xiaomei Xi, Carlsbad, CA (US); Porter Mitchell, San Diego, CA (US)

Correspondence Address: HENSLEY KIM & EDGINGTON, LLC, 1660 LINCOLN STREET, SUITE 3050, DENVER, CO, 80264-3103, US

(21) Appl. No.: 11/603,555

(22) Filed: Nov. 22, 2006

Related U.S. Application Data
(60) Provisional application No. 60/739,186, filed on Nov. 22, 2005.

(51) Int. Cl. H01G 9/00

(52) U.S. Cl. 361/502

(57) ABSTRACT

Particles of active electrode material are made by blending or mixing a mixture of activated carbon, optional conductive carbon, and binder. In selected implementations, binder content in the electrode material is relatively low, typically the binder content of the mixture being between about 3 percent and about 10 percent by weight. The electrode material may be attached to a current collector to obtain an electrode for use in various electrical devices, including a double layer capacitor. The composition of the mixture increases the energy density and the integrity of the electrode.

### CROSS-REFERENCE TO RELATED APPLICATIONS

This application claims the benefit of U.S. provisional application No. 60/739,204 entitled “Double-layer capacitor with good soaking ability” and filed by Xiaomei Xi and Linda Zhong on Nov. 22, 2005, which is hereby incorporated by reference as though fully set forth herein.

### BACKGROUND

The present invention generally relates to electrodes and the fabrication of electrodes. More specifically, the present invention relates to electrodes used in energy storage devices, such as electrochemical double layer capacitors.

Electrodes are widely used in many devices that store electrical energy, including primary (non-rechargeable) battery cells, secondary (rechargeable) battery cells, fuel cells, and capacitors. Important characteristics of electrical energy storage devices include energy density, power density, maximum charging rate, internal leakage current, equivalent series resistance (ESR), and/or durability, i.e., the ability to withstand multiple charge-discharge cycles. For a number of reasons, double layer capacitors, also known as supercapacitors and ultracapacitors, are gaining popularity in many energy storage applications. The reasons include availability of double layer capacitors with high power densities (in both charge and discharge modes), and with energy densities approaching those of conventional rechargeable cells.

Double layer capacitors typically use as their energy storage element electrodes immersed in an electrolyte (an electrolytic solution). As such, a porous separator immersed in and impregnated with the electrolyte may ensure that the electrodes do not come in contact with each other, preventing electronic current flow directly between the electrodes. At the same time, the porous separator allows ionic currents to flow through the electrolyte between the electrodes in both directions. As discussed below, double layers of charges are formed at the interfaces between the solid electrodes and the electrolyte.

When electric potential is applied between a pair of electrodes of a double layer capacitor, ions that exist within the electrolyte are attracted to the surfaces of the oppositely-charged electrodes, and migrate towards the electrodes. A layer of oppositely-charged ions is thus created and maintained near each electrode surface. Electrical energy is stored in the charge separation layers between these ionic layers and the charge layers of the corresponding electrode surfaces. In fact, the charge separation layers behave essentially as electrostatic capacitors. Electrostatic energy can also be stored in the double layer capacitors through orientation and alignment of molecules of the electrolytic solution under influence of the electric field induced by the potential. This mode of energy storage, however, is secondary.

In comparison to conventional capacitors, double layer capacitors have high capacitance in relation to their volume and weight. There are two main reasons for these volumetric and weight efficiencies. First, the charge separation layers are very narrow. Their widths are typically on the order of nanometers. Second, the electrodes can be made from a porous material, having very large effective surface area per unit volume. Because capacitance is directly proportional to the electrode area and inversely proportional to the widths of the charge separation layers, the combined effect of the large effective surface area and narrow charge separation layers is capacitance that is very high in comparison to that of conventional capacitors of similar size and weight. High capacitance of double layer capacitors allows the capacitors to receive, store, and release large amount of electrical energy.

Electrical energy stored in a capacitor is determined using a well-known formula:

$$E = \frac{C * {V}^{2}}{2} . \qquad ( 1 )$$

In this formula, E represents the stored energy, C stands for the capacitance, and V is the voltage of the charged capacitor. Thus, the maximum energy (Eₘ) that can be stored in a capacitor is given by the following expression:

$${E}_{m} = \frac{C * {V}_{r}^{2}}{2} , \qquad ( 2 )$$

where Vᵣ stands for the rated voltage of the capacitor. It follows that a capacitor's energy storage capability depends on both (1) its capacitance, and (2) its rated voltage. Increasing these two parameters may therefore be important to capacitor performance. Indeed, because the total energy storage capacity varies linearly with capacitance and as a second order of the voltage rating, increasing the voltage rating can be the more important of the two objectives.

Conventional methods for fabrication of double layer electrodes such as extrusion and coating typically demand high binder contents of greater than 10% or 15% by weight. These methods which require either laminating an extrusion or coating a slurry onto a collector typically yield substantially non-uniform dispersions of binder material, and high binder quantities reduce the amount of activated carbon available for use in the electrode. This can provide for a relatively low energy density.

A need thus exists for electrodes with higher relative amounts of activated carbon and higher energy densities. A need also exists for methods and materials for making such electrodes, and for electrical devices, including double layer capacitors, using such electrodes.

### SUMMARY

Various implementations hereof are directed to methods, electrodes, electrode assemblies, and electrical devices that may be directed to or may satisfy one or more of the above needs. An exemplar implementation herein disclosed is a method of making particles of active electrode material. In accordance with such a method, particles of activated carbon, optional conductive carbon, and binder may be mixed. In aspects hereof, the binder content of the active electrode material may have a binder component with a presence of between about 3 percent and about 10 percent by weight. In aspects hereof, the binder content may be controlled through reducing the amounts of binder during a dry mixing process.

In accordance with some alternative aspects hereof, the binder is an electrochemically inert binder, such as PTFE. The proportion of the inert binder may be between about 3 and about 10 percent by weight. In accordance with further alternative aspects hereof, mixing of the activated carbon, optional conductive carbon, and binder may be performed by dry-blending these ingredients. In accordance with some further alternative aspects hereof, the mixing may be carried out by subjecting the activated carbon, optional conductive carbon, and binder to a non-lubricated high-shear or high impact force technique. In accordance with still further alternative aspects hereof, films of active electrode material may be made from the particles of active electrode material made as is described herein. The films may be attached to current collectors and used in various electrical devices, for example, in double layer capacitors.

In one implementation, a method of making particles of active electrode material may include providing activated carbon providing binder; and mixing the activated carbon and the binder to obtain a mixture. The method may in some options further include providing conductive carbon particles. In one implementation, the binder may be or may include PTFE. In one implementation, the operation of mixing may include dry blending the activated carbon, conductive carbon, and the binder. In one implementation, the operation of mixing may be performed without processing additives.

In one implementation, an electrode may include a current collector; and a film of active electrode material attached to the current collector, wherein the active electrode material may include binder that makes up between about 3 percent and about 10 percent by weight. The active electrode material may include conductive carbon particles.

In one implementation, a method of making particles of active electrode material may include providing activated carbon; providing optional low contamination level conductive carbon particles; providing binder that makes up between about 3 percent and about 10 percent of the total mixture by weight; and, mixing the activated carbon, the conductive carbon, and the binder to obtain a mixture.

In one implementation, an electrochemical double layer capacitor may include a first electrode comprising a first current collector and a first film of active electrode material, the first film comprising a first surface and a second surface, the first current collector being attached to the first surface of the first film; a second electrode comprising a second current collector and a second film of active electrode material, the second film comprising a third surface and a fourth surface, the second current collector being attached to the third surface of the second film; a porous separator disposed between the second surface of the first film and the fourth surface of the second film; a container; an electrolyte; wherein: the first electrode, the second electrode, the porous separator, and the electrolyte are disposed in the container; the first film is at least partially immersed in the electrolyte; the second film is at least partially immersed in the electrolyte; the porous separator is at least partially immersed in the electrolyte; each of the first and second films may include a mixture of active carbon and of binder that makes up between about 3 percent and about 10 percent by weight. In one implementation, the electrode films further may include conductive carbon. In one implementation, the films are attached to respective collectors via a conductive adhesive layer.

These and other features and aspects of the present invention will be better understood with reference to the following description, drawings, and appended claims.

### BRIEF DESCRIPTION OF THE DRAWINGS

FIG. 1 illustrates selected operations of a process for making active electrode material in accordance with some aspects hereof;

FIG. 2, which includes sub-part FIGS. 2A and 2B, illustrates a cross-section of respective electrode assemblies which may be used in an ultracapacitor;

FIG. 3 is a view of a microstructure of a low binder electrode hereof; and

FIG. 4 is a view of a microstructure of a high binder electrode.

### DETAILED DESCRIPTION

In this document, the words “implementation” and “variant” may be used to refer to a particular apparatus, process, or article of manufacture, and not necessarily always to one and the same apparatus, process, or article of manufacture. Thus, “one implementation” (or a similar expression) used in one place or context can refer to one particular apparatus, process, or article of manufacture; and, the same or a similar expression in a different place can refer either to the same or to a different apparatus, process, or article of manufacture. Similarly, “some implementations,” “certain implementations,” or similar expressions used in one place or context may refer to one or more particular apparatuses, processes, or articles of manufacture; the same or similar expressions in a different place or context may refer to the same or a different apparatus, process, or article of manufacture. The expression “alternative implementation” and similar phrases are used to indicate one of a number of different possible implementations. The number of possible implementations is not necessarily limited to two or any other quantity. Characterization of an implementation as “an exemplar” or “exemplary” means that the implementation is used as an example. Such characterization does not necessarily mean that the implementation is a preferred implementation; the implementation may but need not be a currently preferred implementation.

The expression “active electrode material” and similar phrases signify material that provides or enhances the function of the electrode beyond simply providing a contact or reactive area approximately the size of the visible external surface of the electrode. In a double layer capacitor electrode, for example, a film of active electrode material includes particles with high porosity, so that the surface area of the electrode exposed to an electrolyte in which the electrode is immersed may be increased well beyond the area of the visible external surface; in effect, the surface area exposed to the electrolyte becomes a function of the volume of the film made from the active electrode material.

The meaning of the word “film” is similar to the meaning of the words “layer” and “sheet”; the word “film” does not necessarily imply a particular thickness or thinness of the material. When used to describe making of active electrode material film, the terms “powder,” “particles,” and the like refer to a plurality of small granules. As a person skilled in the art would recognize, particulate material is often referred to as a powder, grain, specks, dust, or by other appellations. References to carbon and binder powders throughout this document are thus not meant to limit the present implementations.

The references to “binder” within this document are intended to convey the meaning of polymers, co-polymers, and similar ultra-high molecular weight substances capable of providing a binding for the carbon. Such substances may be employed as binders for promoting cohesion in loosely-assembled particulate materials, i.e., active filler materials that perform some useful function in a particular application.

The words “calender,” “nip,” “laminator,” and similar expressions mean a device adapted for pressing and compressing. Pressing may be, but is not necessarily, performed using rollers. When used as verbs, “calender” and “laminate” mean processing in a press, which may, but need not, include rollers. Mixing or blending as used herein may mean processing which involves bringing together component elements into a mixture. High shear or high impact forces may be, but are not necessarily, used for such mixing. Example equipment that can be used to prepare/mix the dry powder(s) hereof may include, in non-limiting fashion: a ball mill, an electromagnetic ball mill, a disk mill, a pin mill, a high-energy impact mill, a fluid energy impact mill, an opposing nozzle jet mill, a fluidized bed jet mill, a hammer mill, a fritz mill, a Warring blender, a roll mill, a mechanofusion processor (e.g., a Hosokawa AMS), or an impact mill.

Other and further definitions and clarifications of definitions may be found throughout this document. The definitions are intended to assist in understanding this disclosure and the appended claims, and the scope and spirit of the invention should not be construed as strictly limited to the particular examples described in this specification.

Reference will now be made in detail to several illustrations of the invention that are illustrated in the accompanying drawings. The same reference numerals are used in the drawings and the description to refer to the same or substantially the same parts or operations. The drawings are in simplified form and not to precise scale. For purposes of convenience and clarity only, directional terms, such as top, bottom, left, right, up, down, over, above, below, beneath, rear, and front may be used with respect to the accompanying drawings. These and similar directional terms, should not be construed to limit the scope of the invention.

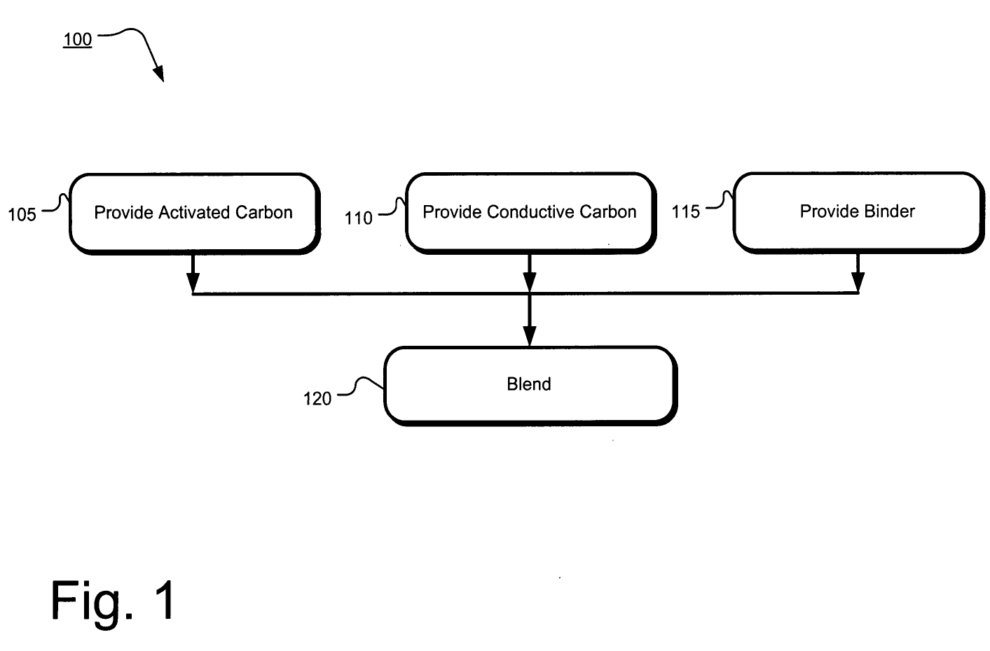

Referring more particularly to the drawings, FIG. 1 illustrates selected operations of a process 100 for making active electrode material. Although the process operations are described substantially serially, certain operations may also be performed in alternative order, in conjunction or in parallel, in a pipelined manner, or otherwise. There is no particular requirement that the operations be performed in the same order in which this description lists them, except where explicitly so indicated, otherwise made clear from the context, or inherently required. Not all illustrated operations may be strictly necessary, while other optional operations may be added to the process 100. A high level overview of the process 100 is provided immediately below. A more detailed description of the operations of the process 100 and variants of the operations are provided following the overview.

In one implementation of a process 100, an operation 105 may provide activated carbon particles and in an optional operation 110, optional conductive carbon particles with low contamination level and high conductivity may be provided. In operation 115, binder may be provided. In one or more implementations, and although one or more of a variety of binders may be used as described elsewhere herein, the binder may include polytetraflouroethylene (also known as PTFE or by the tradename, “Teflon®”). In the mixing or blending operation 120 hereof, one or more of the activated carbon, conductive carbon, and binder may be blended or mixed; typically two or more may be mixed together, most typically, the activated carbon is mixed with the binder. Alternatively, in certain implementations one of the activated carbon or conductive carbon ingredients and/or operations may be omitted. It should be understood that no implementations are to be limited to particular brands or suppliers of carbon, binder, or other materials.

Set forth herein are more detailed descriptions of low-binder electrode structures and the processes by which these may be made. It has been found that electrodes made with less binder content and higher activated carbon content have better energy density than electrodes made with higher binder content and lower activated carbon content. Accordingly, in some implementations hereof the binder content is between about 3 percent and about 10 percent by weight of the total weight of the electrode.

Table I below shows a comparison of the energy density of a high binder electrode and of two alternative low binder electrodes:

TABLE I

| Electrode binder | |
|---|---|
| amount (wt %) | F/CC |
| ˜25% | 16.3 |
| 10% | 17.3 |
| 5% | 15.96 |

The energy density representations of Table I are demonstrated by the respective capacitive quantities of farads per cubic centimeter (F/CC) of alternative binder content electrodes. Higher faradic capacities will provide better effectiveness of the electrode by better energy storage and lower effective series resistance (ESR). The approximate 25% binder content yields a farad/cc value of 16.3 which compares less favorably against the 10% binder content yield of 17.3. Note, though not as favorable, the 5% binder content example still provides a comparable and/or otherwise acceptable 15.96 F/CC. Even so, the less binder used, the lower the ESR, as binder is resistive, and thus a still more effective electrode may be provided. The converse of less binder is the addition of more active material, such as the activated carbon which may provide a higher energy density (see the difference between the 25% and 10% binder contents of Table I), and thus better energy storage.

In the provision of a binder, one or more of a variety of alternative binders may be provided, as for example: PTFE in granular powder form, and/or one or more of various other fluoropolymer particles, or polypropylene, or polyethylene, or co-polymers, and/or other polymer blends. It has been identified that the use of inert binders such as PTFE, tends to increase the voltage at which an electrode including such an inert binder may be operated. Such an increase may occur in part due to reduced interactions with electrolyte in which the electrode is subsequently immersed. In one implementation, typical diameters of the PTFE particles may be in the five hundred micron range.

In the mixing process, the activated carbon particles and binder particles may be blended or otherwise mixed together in a variety of proportions. In various implementations, proportions of activated carbon and binder may be as follows: about 90 to about 97 percent by weight of activated carbon, about 3 to about 10 percent by weight of PTFE. Optional conductive carbon could be added in a range of about 0 to about 15 percent by weight. An implementation may contain about 94.5 percent of activated carbon, about 5 percent of PTFE, and about 0.5 percent of conductive carbon. Other ranges are within the scope hereof as well. Note that all percentages are here presented by weight, though other percentages with other bases may be used. Conductive carbon may be preferably held to a low percentage of the mixture because an increased proportion of conductive carbon may tend to lower the breakdown voltage of electrolyte in which an electrode made from the conductive carbon particles is subsequently immersed.

In an implementation of the mixing process 100, the blending operation 120 may be a “dry-blending” operation, i.e., blending of activated carbon, conductive carbon, and/or binder is performed without the addition of any solvents, liquids, processing aids, or the like to the particle mixture. Dry-blending may be carried out, for example, for about 1 to about 10 minutes in a mill, mixer, or blender (such as a V-blender equipped with a high intensity mixing bar, or other alternative equipment as described further below), until a uniform dry mixture is formed. Those skilled in the art will identify, after perusal of this document, that blending time can vary based on batch size, materials, particle size, densities, as well as other properties, and yet remain within the scope hereof.

As introduced above, the blended powder material may also or alternatively be formed/mixed/blended using other equipment. Such equipment that can be used to prepare/mix dry powder(s) hereof may include, for non-limiting examples: blenders of many sorts including rolling blenders and warring blenders, and mills of many sorts including ball mills, electromagnetic ball mills, disk mills, pin mills, high-energy impact mills, fluid energy impact mills, opposing nozzle jet mills, fluidized bed jet mills, hammer mills, fritz mills, roll mills, mechanofusion processing (e.g., a Hosokawa AMS), or impact mills. In an implementation, dry powder material may be mixed using non-lubricated high-shear or high impact force techniques. In an implementation, high-shear or high impact forces may be provided by a mill such as one of those described above. The powder material, binder and carbon, may be introduced into the mill, wherein high-velocities and/or high forces could then be directed at or imposed upon the powder material to effectuate application of high shear or high impact to the binder within the powder material. The shear or impact forces that arise during the dry mixing process may physically affect the binder, causing the binder to bind the binder to and/or with other particles within the material. A dry mixing process is described in more detail in a co-pending commonly-assigned U.S. patent application Ser. No. 11/116,882. This application is hereby incorporated by reference for all it discloses as if fully set forth herein, including all figures, tables, and claims. It should also be noted that references to dry mixing, dry-blending, dry particles, and other dry materials and processes used in the manufacture of an active electrode material and/or film do not exclude the use of other than dry processes, for example, this may be achieved after drying of particles and films that may have been prepared using a processing aid, liquid, solvent, or the like.

The mixing process whereby the constituent materials may be mixed as described above results in a breakdown of the larger polymer binder agglomerates of the pre-mixed binder into smaller polymer agglomerates and/or primary particles. The smaller polymer binder agglomerates and/or primary particles that result from the mixing process may disperse substantially uniformly throughout the powder mixture during the course of the mixing process. Either or both of the breakdown to smaller agglomerates and/or the substantially uniform dispersion of smaller polymer agglomerates, and the smaller size of the polymer agglomerates, may result in an increased surface area of totality of binder as many smaller particles within a given volume provide greater surface area than fewer larger particles. The result of the greater surface area of the smaller agglomerates or particles, as well as their more uniform and more proximate placement with relation to each other, may be enhanced binding properties for each binder agglomerate or particle. The enhanced binding capability of the smaller agglomerates or particles may reduce the need for larger amounts of binder by weight in the mixture.

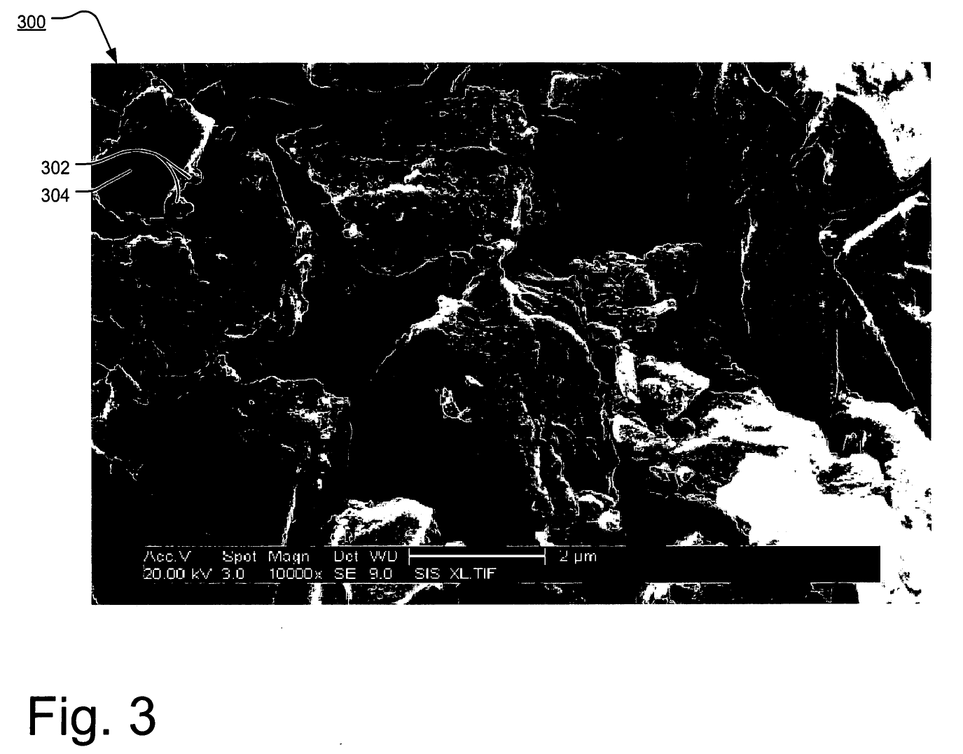

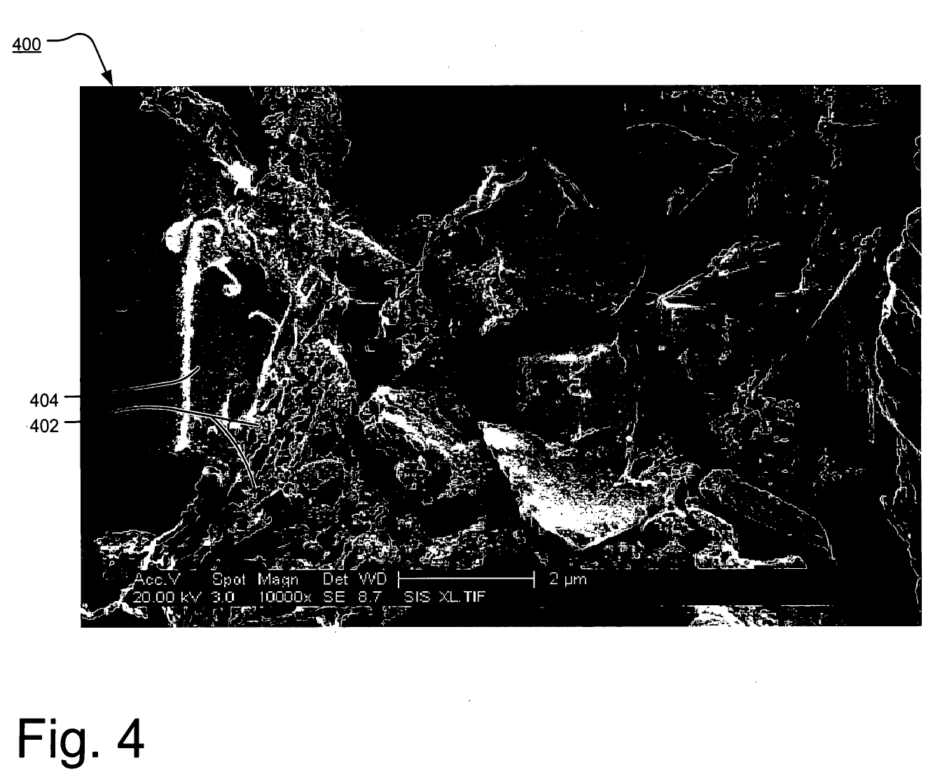

FIG. 3 illustrates a cross-section of a low binder electrode 300 made from a mixing process hereof. A substantially uniformly dispersed binder material 302 is shown on and/or between particles of activated carbon 304. The activated carbon content of the shown electrode 300 is between about 90% and about 91% by weight, where the binder is between about 6% and about 7% by weight (more particularly in the example shown, activated carbon is at about 90.87% and binder is at about 6.89%, with a ratio of about 13.19:1). Fabrication of a low binder electrode may be by one or more of a number of mixing processes as further described hereinabove. By contradistinction, FIG. 4 illustrates a cross-section of a high binder electrode 400 made from an extrusion process. A substantially non-uniformly dispersed binder material 402 appears on and/or between the particles of activated carbon 404. The lower left comer representation of binder 402 is particularly un-dispersed in this example. Because the binder is present in larger units in the high binder electrode, more binder is present by weight in the electrode. Accordingly, the large amount of binder material decreases the amount of activated carbon in the electrode and thus decreases the energy density. More specifically here, the activated carbon content of the shown electrode 400 is between about 77% and about 78% by weight, where the binder is at about 20% by weight (more particularly in the example shown, activated carbon is at about 77.17% and binder is at about 20.09%, with a ratio of about 3.84:1).

A product obtained through such a mixing process may be used to make an electrode film. The films may then be bonded to a current collector, such as a foil made from aluminum or another conductor. The current collector can be a continuous metal foil, metal mesh, or nonwoven metal fabric. The metal current collector provides a continuous electrically conductive substrate for the electrode film. The current collector may be pretreated prior to bonding to enhance its adhesion properties. Pretreatment of the current collector may include mechanical roughing, chemical pitting, and/or use of a surface activation treatment, such as corona discharge, active plasma, ultraviolet, laser, or high frequency treatment methods known to a person skilled in the art. In one implementation, the electrode films may be bonded to a current collector via an intermediate layer of conductive adhesive known to those skilled in the art.

In one implementation, a product obtained from the mixing process may be mixed with a processing aid to obtain a slurry-like composition used by those skilled in the art to coat an electrode film onto a collector (i.e. a coating process). The slurry may be then deposited on one or both sides of a current collector. After a drying operation, a film or films of active electrode material may be formed on the current collector. The current collector with the films may be calendered one or more times to densify the films and to improve adhesion of the films to the current collector.

In one implementation, a product obtained from the mixing process may be mixed with a processing aid to obtain a paste-like material. The paste-like material may be then be extruded, formed into a film, and deposited on one or both sides of a current collector. After a drying operation, a film or films of active electrode material may be formed on the current collector. The current collector with the dried films may be calendered one or more times to densify the films and to improve adhesion of the films to the current collector.

In yet another implementation, in a product obtained through a mixing process hereof, the binder particles may include thermoplastic or thermoset particles. A product obtained through a mixing process hereof that includes thermoplastic or thermoset particles may be used to make an electrode film. Such a film may then be bonded to a current collector, such as a foil made from aluminum or another conductor. The films may be bonded to a current collector in a heated calendar apparatus. The current collector may be pretreated prior to bonding to enhance its adhesion properties. Pretreatment of the current collector may include mechanical roughing, chemical pitting, and/or use of a surface activation treatment, such as corona discharge, active plasma, ultraviolet, laser, or high frequency treatment methods known to a person in the art.

Electrode products that include an active electrode film attached to a current collector and/or a porous separator may be used in an ultracapacitor or a double layer capacitor and/or other electrical energy storage devices. Other methods of forming the active electrode material films and attaching the films to the current collector may also be used.

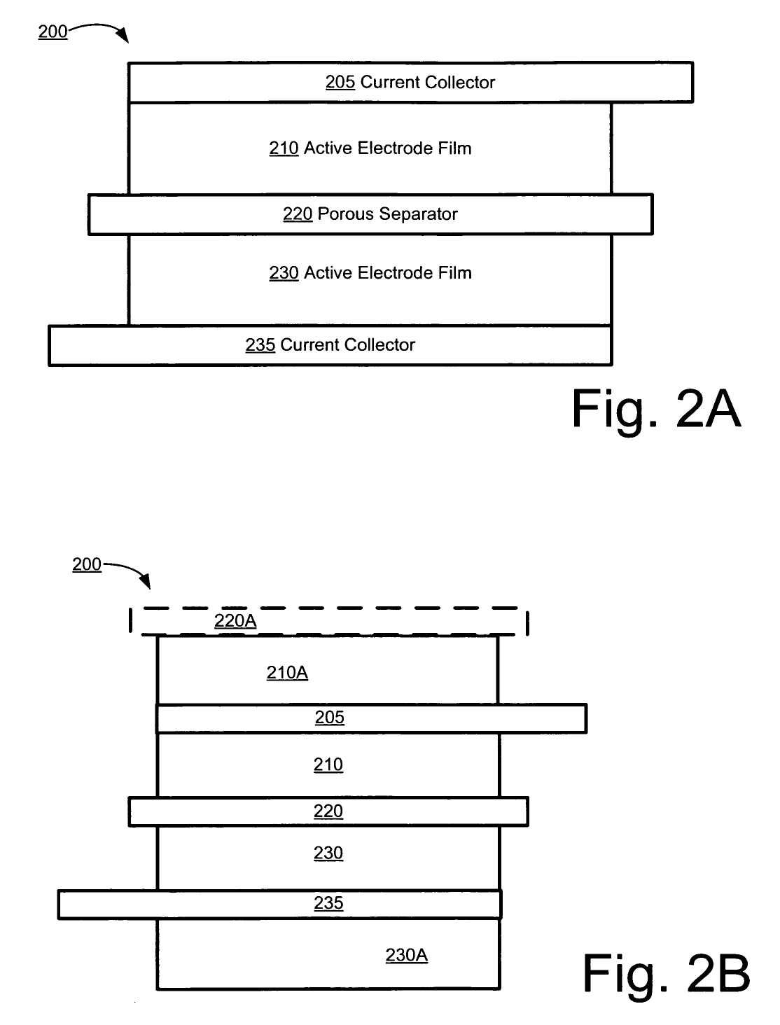

FIG. 2, including sub FIGS. 2A and 2B, illustrates in a high level manner, respective cross-sectional views of an electrode assembly 200 of which may be used in an ultracapacitor or a double layer capacitor. In FIG. 2A, the components of the assembly 200 are arranged in the following order: a first current collector 205, a first active electrode film 210, a porous separator 220, a second active electrode film 230, and a second current collector 235. In some implementations, a conductive adhesive layer (not shown) may be disposed on current collector 205 prior to bonding of the electrode film 210 (or likewise on collector 235 relative to film 230). In FIG. 2B, a double layer of films 210 and 210 are shown relative to collector 205, and a double layer 230, 230A relative to collector 235. In this way, a double-layer capacitor may be formed, i.e., with each current collector having a carbon film attached to both sides. A further porous separator 220A may then also be included, particularly for a jellyroll application, the porous separator 220A either attached to or otherwise disposed adjacent the top film 210A, as shown, or to or adjacent the bottom film 230A (not shown). The films 210 and 230 (and 210A and 230A, if used) may be made using particles of active electrode material obtained through the process 100 described in relation to FIG. 1. An exemplary double layer capacitor using the electrode assembly 200 may further include an electrolyte and a container, for example, a sealed can, that holds the electrolyte. The assembly 200 may be disposed within the container (can) and immersed in the electrolyte. In many implementations, the current collectors 205 and 235 may be made from aluminum foil, the porous separator 220 may be made from one or more ceramics, paper, polymers, polymer fibers, glass fibers, and the electrolytic solution may include in some examples, 1.5 M tetramethylammonium tetrafluroborate in organic solutions, such as PC or Acetronitrile solvent.

Electrodes, particularly in many examples, double layer electrodes have thus herein been shown be fabricated by a process or method, typically dry, by substantially uniformly dispersing binder material relative to an activated carbon powder. Using high force, shear or impact or both, less than 10% by weight binder contents may be formed. As little as 3% by weight binder has been used without comprise to the integrity of the electrode. As the binder is more dispersed using high force mixing, less binder may be used and thus higher energy density is possible. Some advantages may include low cost processes, higher energy density and/or lower ESR electrodes may be obtained, even with typical, conventional activated carbon materials. Note, conventional supercapacitors often suffer from low energy density; thus, packing higher percentages of activated carbon into the electrode can improve the energy density of the electrode. Moreover, in some instances, even higher integrity electrodes may result due to higher dispersions of binder material throughout a mixture of binder with carbon.

The inventive methods for making active electrode material, films of these materials, electrodes made with the films, and double layer capacitors employing the electrodes have been described above in considerable detail. This was done for illustrative purposes. Neither the specific implementations of the invention as a whole, nor those of its features, limit the general principles underlying the invention. In particular, the invention is not necessarily limited to the specific constituent materials and proportions of constituent materials used in making the electrodes. The invention is also not necessarily limited to electrodes used in double layer capacitors, but extends to other electrode applications. The specific features described herein may be used in some implementations, but not in others, without departure from the spirit and scope of the invention as set forth. Many additional modifications are intended in the foregoing disclosure, and it will be appreciated by those of ordinary skill in the art that, in some instances, some features of the invention will be employed in the absence of other features. The illustrative examples therefore do not define the metes and bounds of the invention and the legal protection afforded the invention, which function is served by the claims and their equivalents.

Accordingly, what is claimed is:

1. A method of making an active electrode material, the method comprising:
providing activated carbon;
providing binder; and,
mixing the activated carbon and the binder to obtain a mixture, wherein the mixture results with a binder content in the range of about 3% percent and about 10% by weight of the total mixture.

2. A method in accordance with claim 1, wherein the operation of providing the activated carbon includes providing activated carbon in amount of between about 90 and about 97 percent by weight.

3. A method in accordance with claim 1, wherein the operation of providing the binder includes providing one or more of fluoropolymer particles; polytetrafluoroethylene (PTFE); PTFE in granular powder form; polypropylene; polyethylene; co-polymers, and/or polymer blends.

4. A method in accordance with claim 1, further including providing an additional additive component of conductive carbon.

5. A method in accordance with claim 1, wherein the operation of mixing includes dry blending the activated carbon and the binder.

6. A method according to claim 1 wherein the operation of mixing includes substantially uniformly dispersing the binder within the activated carbon.

7. A method according to claim 1 wherein the operation of mixing includes introducing one or more of high shear and high impact forces to the activated carbon and the binder to obtain a mixture of active electrode material.

8. A method according to claim 1 wherein the operation of mixing includes introducing one or more of high shear and high impact forces to the activated carbon and the binder to obtain a substantial dispersion of the binder within the mixture of active electrode material.

9. A method according to claim 1 wherein the operation of mixing includes a breakdown of larger polymer agglomerates of binder into one or both of smaller polymer agglomerates and primary particles.

10. A method according to claim 1 wherein the operation of mixing includes a breakdown of larger polymer agglomerates of binder into one or both of smaller polymer agglomerates and primary particles, either or both presenting one or both of an increased surface area of the totality of the binder and a substantially uniform dispersion of binder within the mixture.

11. A method according to claim 10 further providing enhanced binding capacity.

12. A method according to claim 1 wherein the mixing operation includes using one or both of a blender and a mill.

13. A method according to claim 1 wherein the mixing operation includes using one or more of a ball mill, an electromagnetic ball mill, a disk mill, a pin mill, a high-energy impact mill, a fluid energy impact mill, an opposing nozzle jet mill, a fluidized bed jet mill, a hammer mill, a fritz mill, a Warring blender, a roll mill, a mechanofusion processor, a Hosokawa AMS, or an impact mill.

14. A method in accordance with claim 1, wherein the operation of mixing is performed using a mixing apparatus having at least one ceramic surface in contact with one or more of the activated carbon, the binder and the mixture during mixing.

15. An electrode comprising:
a current collector; and
a film of active electrode material attached to the current collector, wherein the active electrode material has a mixture including one or both of an activated carbon component and a conductive carbon component; mixed with a binder component, the binder component being in the range of between about 3% percent and about 10% by weight of the total mixture of the active electrode material.

16. An electrode according to claim 15, wherein the active electrode material includes activated carbon and a binder, wherein the activated carbon is in an amount of between about 90 and about 97 percent by weight, and wherein the binder is in an amount of between about 3 and about 10 percent by weight.

17. An electrode according to claim 15, wherein the active electrode material is formed from a mixture of activated carbon and binder, the mixture formed through mixing with a dry process.

18. An electrode according to claim 15 wherein the binder is one or more of small polymer agglomerates and primary particles, either or both presenting one or both of an increased surface area for a totality of the binder and a substantially uniform dispersion of binder within the mixture.

19. An electrochemical double layer capacitor comprising:
a first electrode comprising a first current collector and a first film of active electrode material, the first film comprising a first surface and a second surface, the first current collector being attached to the first surface of the first film;
a second electrode comprising a second current collector and a second film of active electrode material, the second film comprising a third surface and a fourth surface, the second current collector being attached to the third surface of the second film;
a porous separator disposed between the second surface of the first film and the fourth surface of the second film;
a container;
an electrolyte; wherein:
the first electrode, the second electrode, the porous separator, and the electrolyte are disposed in the container;
the first film is at least partially immersed in the electrolyte;
the second film is at least partially immersed in the electrolyte;
the porous separator is at least partially immersed in the electrolyte;
each of the first and second films include a mixture of carbon and binder with a binder content of between about 3 percent and about 10 percent by weight.

20. A capacitor according to claim 19, wherein the active electrode material includes activated carbon and a binder, wherein the activated carbon is in an amount of between about 90 and about 97 percent by weight, and wherein the binder is in an amount of between about 3 and about 10 percent by weight.
